(19) United States
(12) Patent Application Publication
(10) Pub. No.: US 2010/0138498 A1
(43) Pub. Date: Jun. 3, 2010

(54) Method and Apparatus for Opening a Program Based on a Communication That Has Not Been Accessed

(75) Inventor: Juhana Mikael Jaakkola, Turku (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/327,035

(22) Filed: Dec. 3, 2008

(51) Int. Cl. G06F 15/16; G06K 9/00

(52) U.S. Cl. 709/206; 382/124

(57) ABSTRACT

In accordance with an example embodiment of the present invention, an apparatus, comprising a processor configured to receive a communication, the communication having not been accessed, activate an interactive area based at least in part on the communication not being accessed, and receive a signal from a selection of the interactive area.

### TECHNICAL FIELD

The present application relates generally to opening a program based on a communication that has not been accessed.

### BACKGROUND

Electronic devices include many different features. As such, features for electronic devices are increasing in number. Thus, the electronic device facilitates a better user experience.

### SUMMARY

Various aspects of examples of the invention are set out in the claims.

According to a first aspect of the present invention, an apparatus, comprising a processor configured to receive a communication, the communication having not been accessed, activate an interactive area based at least in part on the communication not being accessed, and receive a signal from a selection of the interactive area.

According to a second aspect of the present invention, a method, comprising receiving a communication, the communication having not been accessed, activating an interactive area based at least in part on the communication not being accessed, and receiving a signal from a selection of the interactive area.

### BRIEF DESCRIPTION OF THE DRAWINGS

For a more complete understanding of example embodiments of the present invention, reference is now made to the following descriptions taken in connection with the accompanying drawings in which:

FIG. 1 is a block diagram depicting an electronic device operating in accordance with an example embodiment of the invention;

FIG. 2 is a block diagram depicting an electronic device for receiving a communication in accordance with an example embodiment of the invention;

FIG. 3 is a block diagram depicting an electronic device having a biometric reader for authenticating a user in accordance with an example embodiment of the invention;

FIG. 4 is a block diagram depicting a selecting an indicator on an electronic device in accordance with an example embodiment of the invention; and

FIG. 5 is a flow diagram depicting an example method for receiving a signal from a selection of an interactive area in accordance with an example embodiment of the invention.

### DETAILED DESCRIPTON OF THE DRAWINGS

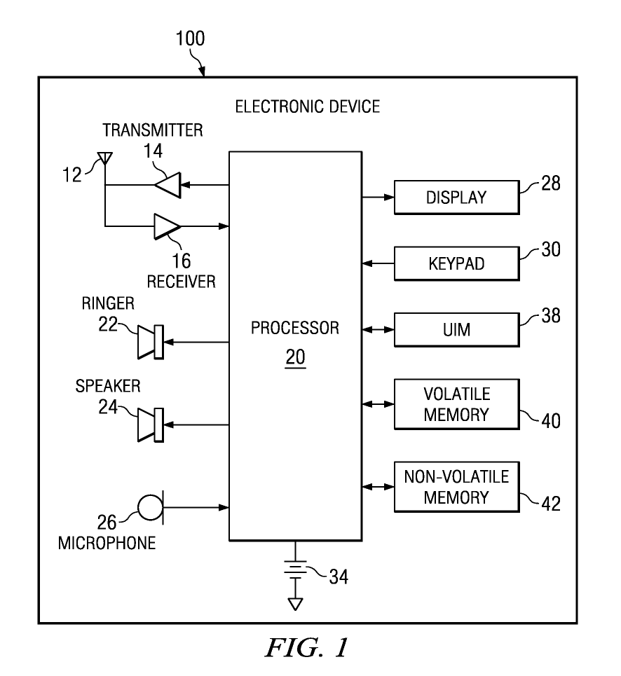

An example embodiment of the present invention and its potential advantages are best understood by referring to FIGS. 1 through 5 of the drawings.

FIG. 1 is a block diagram depicting an electronic device 100 operating in accordance with an example embodiment of the invention. In an example embodiment, an electronic device 100 comprises at least one antenna 12 in communication with a transmitter 14, a receiver 16, and/or the like. The electronic device 100 may further comprise a processor 20 or other processing component. The processor 20 may provide at least one signal to the transmitter 14 and may receive at least one signal from the receiver 16. In an embodiment, the electronic device 100 also comprises a user interface comprising one or more input or output devices, such as a conventional earphone or speaker 24, a ringer 22, a microphone 26, a display 28, and/or the like. In an embodiment, the one or more output devices of the user interface are coupled to the processor 20.

In an example embodiment, the user interface allows the electronic device 100 to receive or transmit data. For example, the user interface comprises any of a number of devices configured to receive data, such as a keypad 30, a touch display, other input device, and/or the like. In an embodiment, the keypad 30 comprises the conventional numeric, e.g., 0-9, and/or related keys, e.g., #, *, other hard and/or soft keys, and/or the like to operate the electronic device 100. In an alternative embodiment, the keypad 30 comprises a conventional QWERTY keypad arrangement. Further, the keypad 30 may also comprise various soft keys with associated features. If desired, the electronic device 100 may comprise a user interface device, such as a joystick or the like.

In an embodiment, the electronic device 100 also comprises a battery 34, such as a vibrating battery pack, for powering various circuits to operate the electronic device 100. Further, the vibrating battery pack may also provide mechanical vibration as a detectable output. In an embodiment, the electronic device 100 further comprises a user identity module (UIM) 38. In one embodiment, the UIM 38 is a memory device comprising a processor. The UIM 38 may comprise, for example, a subscriber identity module (SIM), a universal integrated circuit card (UICC), a universal subscriber identity module (USIM), a removable user identity module (R-UIM), and/or the like. Further, the UIM 38 may store one or more information elements related to a subscriber, such as a mobile subscriber.

In an embodiment, the electronic device 100 comprises memory. For example, the electronic device 100 may comprise volatile memory 40, such as random access memory (RAM). Volatile memory 40 may comprise a cache area for the temporary storage of data. Further, the electronic device 100 may also comprise non-volatile memory 42, which may be embedded and/or may be removable. The non-volatile memory 42 may also comprise an electrically erasable programmable read only memory (EEPROM), flash memory, and/or the like. In an alternative embodiment, the processor 20 comprises memory. For example, the processor 20 may comprise volatile memory 40, non-volatile memory 42, and/or the like.

In an embodiment, the electronic device 100 uses memory to store any of a number of pieces of information and/or data to implement one or more features of the electronic device 100. Further, the memory may comprise an identifier, such as international mobile equipment identification (IMEI) code, capable of uniquely identifying the electronic device 100. The memory may store one or more instructions for determining cellular identification information based at least in part on the identifier. For example, the processor 20, using the stored instructions, may determine an identity, e.g., cellular identification identity or cellular identification information, of a communication with the electronic device 100.

In an embodiment, the processor 20 of the electronic device 100 comprises circuitry for implementing audio feature, logic features, and/or the like. For example, the processor 20 may comprise a digital signal processor device, a microprocessor device, a digital to analog converter, other support circuits, and/or the like. In an embodiment, control and signal processing features of the processor 20 are allocated between devices, such as the devices describe above, according to their respective capabilities. Further, the processor 20 may also comprise an internal voice coder and/or an internal data modem. Further still, the processor 20 may comprise features to operate one or more software programs. For example, the processor 20 may be capable of operating a software program for connectivity, such as a conventional Internet browser. Further, the connectivity program may allow the electronic device 100 to transmit and receive Internet content, such as location-based content, other web page content, and/or the like. In an embodiment, the electronic device 100 uses a wireless application protocol (WAP), hypertext transfer protocol (HTTP), file transfer protocol (FTP) and/or the like to transmit and/or receive the Internet content.

In an embodiment, the electronic device 100 is capable of operating in accordance with any of a number of a first generation communication protocol, a second generation communication protocol, a third generation communication protocol, a fourth generation communication protocol, and/or the like. For example, the electronic device 100 may be capable of operating in accordance with second generation (2G) communication protocols IS-136, time division multiple access (TDMA), global system for mobile communication (GSM), IS-95 code division multiple access (CDMA), and/or the like. Further, the electronic device 100 may be capable of operating in accordance with third-generation (3G) communication protocols, such as Universal Mobile Telecommunications System (UMTS), CDMA2000, wideband CDMA (WCDMA), time division-synchronous CDMA (TD-SCDMA), and/or the like. Further still, the electronic device 100 may also be capable of operating in accordance with 3.9 generation (3.9G) wireless communication protocols, such as Evolved Universal Terrestrial Radio Access Network (E-UTRAN) or the like, or wireless communication projects, such as long term evolution (LTE) or the like. Still further, the electronic device 100 may be capable of operating in accordance with fourth generation (4G) communication protocols.

In an alternative embodiment, the electronic device 100 is capable of operating in accordance with a non-cellular communication mechanism. For example, the electronic device 100 may be capable of communication in a wireless local area network (WLAN), other communication networks, and/or the like. Further, the electronic device 100 may communicate in accordance with techniques, such as radio frequency (RF), infrared (IrDA), any of a number of WLAN techniques. For example, the electronic device 100 may communicate using one or more of the following WLAN techniques: IEEE 802.11, e.g., 802.11a, 802.11b, 802.11g, 802.11n, and/or the like. Further, the electronic device 100 may also communicate, via a world interoperability, to use a microwave access (WiMAX) technique, such as IEEE 802.16, and/or a wireless personal area network (WPAN) technique, such as IEEE 802.15, BlueTooth (BT), ultra wideband (UWB), and/or the like.

It should be understood that the communications protocols described above may employ the use of signals. In an example embodiment, the signals comprise signaling information in accordance with the air interface standard of the applicable cellular system, user speech, received data, user generated data, and/or the like. In an embodiment, the electronic device 100 is capable of operating with one or more air interface standards, communication protocols, modulation types, access types, and/or the like. It should be further understood that the electronic device 100 is merely illustrative of one type of electronic device that would benefit from embodiments and, therefore, should not be taken to limit the scope of embodiments.

While embodiments of the electronic device 100 are illustrated and will be hereinafter described for purposes of example, other types of electronic devices, such as a portable digital assistant (PDA), a pager, a mobile television, a gaming device, a camera, a video recorder, an audio player, a video player, a radio, a mobile telephone, a traditional computer, a portable computer device, a global positioning system (GPS) device, a GPS navigation device, a GPS system, a mobile computer, a browsing device, an electronic book reader, a combination thereof, and/or the like, may be used. While several embodiments of the invention may be performed or used by the electronic device 100, embodiments are also be employed by a server, a service, a combination thereof, and/or the like.

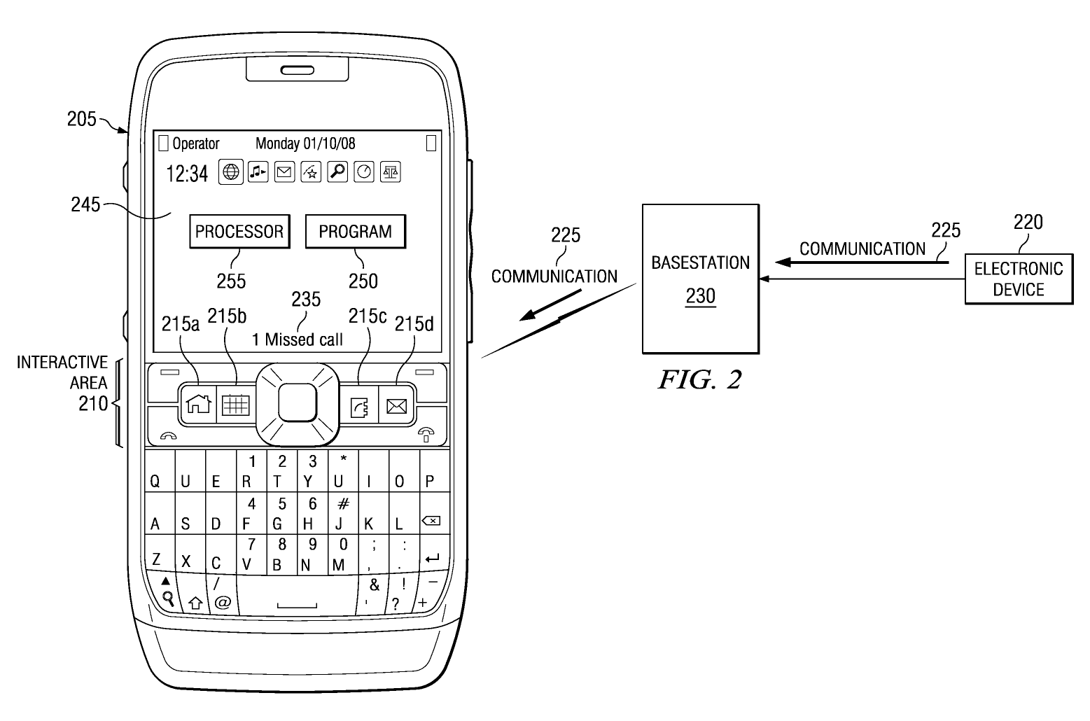

FIG. 2 is a block diagram depicting an electronic device 205 for receiving a communication 225 in accordance with an example embodiment of the invention. In an example embodiment, the electronic device 205 is in communication with a basestation 230. The basestation 230 may be in communication with an electronic device 220, a server, and/or the like. In an embodiment, the electronic device 205 comprises a processor 255, a user interface 245, an interactive area 210, a plurality of indicators 215a-d, and/or the like. In an example embodiment, electronic device 205 is similar to electronic device 100 of FIG. 1 and processor 255 is similar to processor 20 of FIG. 1. In an alternative embodiment, electronic device 205 and processor 255 may be different than electronic device 100 and processor 20 of FIG. 1.

In an example embodiment, the processor 255 of the electronic device 205 is configured to receive a communication 225. For example, the electronic device 205 receives the communication 225, such as a mobile communication, via the basestation 230, from another electronic device 220. In an example embodiment, the communication 225 is at least one of the following: an email, a mobile communication, a calendar reminder, a calendar appointment, a message, and/or the like.

In an example embodiment, the communication 225 has not been accessed. For example, the electronic device 205 receives a phone call which is not accessed, e.g., a missed call. In an example embodiment, the processor 255 is configured to activate an interactive area 210 based at least in part on the communication 225 not being accessed. For example, the interactive area 210 becomes active based at least in part on the missed call. In an alternative embodiment, the interactive area 210 becomes active based at least in part a calendar appointment and/or a calendar reminder. For example, the interactive area 210 related to the calendar may blink or otherwise become active. In an example embodiment, accessing the communication relates to at least one of the following: answering a mobile communication, viewing a received email, viewing a received message, viewing a calendar reminder, viewing a calendar appointment, viewing a really simple syndication (RSS) feed, and/or the like.

In an embodiment, a RSS feed may be a really simple syndication reader, rich summary site reader, resource description framework (RDF) summary site reader, and/or the like. Further, RSS may be a family of web feed formats used to publish frequently updated content such as blog entries, news headlines, podcasts in a standardized format and/or the like. An RSS document, e.g., a feed, a web feed, a channel, and/or the like, may comprise either a summary of content from an associated web site, the full text, and/or the like.

In an example embodiment, the interactive area 210 comprises a plurality of indicators 215a-d. In an embodiment, at least one of the plurality of indicators 215a-d is at least one of the following: a hard key, a soft key, a touch screen, a biometric reader, and/or the like. In an embodiment, the plurality of indicators 215a-d relate to at least one of the following: answering a mobile communication, viewing a received email, viewing a calendar reminder, viewing a calendar appointment, or viewing a received message. In an alternative embodiment, the interactive area 210 may be at least one of the following: a hard key, a soft key, a touch screen, a biometric reader, and/or the like.

In an example embodiment, at least one indicator of the plurality of indicators 215a-d is illuminated. In an embodiment, the processor 255 is configured to illuminate an indicator, such as indicator 215c, to indicate a missed call. In an embodiment, the user interface 245 may also display a text indicator 235, such as “1 missed call.” In an alternative embodiment, the processor 255 may be configured to partially illuminate the indicator 215c on the interactive area 210. For example, the processor 255 illuminates a portion of the indicator 215c. In an alternative embodiment, at least one of the plurality of indicators 215a-d may blink consistent with the number of communications not accessed. For example, indicator 215c may blink four times and stop to indicate four missed calls. In an embodiment, the indicator 215c may repeat the blinking after stopping. It should be understood that example embodiments may also illuminate, partially illuminate, and/or blink the interactive area 210.

In an example embodiment, the processor 255 is configured to receive a signal from a selection of the interactive area 210. For example, the processor 255 receives a signal based at least in part on a user selection, such as pressing the indicator 215c.

In an embodiment, the electronic device 205 is locked. Further, the user interface 245 is configured to receive authentication information to be accessed. For example, the user interface 245 is awaiting a user name and password to unlock the electronic device 205. In an embodiment, the signal received by the processor 255 comprises authentication information and/or a command associated with the received communication. In an example embodiment, the command is an open command for a program. For example, the signal comprises a user name and password and a command to open a missed call program.

In an example embodiment, the processor 255 is further configured to open a program associated with the communication. For example, the processor 255 opens the missed calls program based at least in part on the command in the signal, which is associated with the communication 225, e.g., a missed call. In an example embodiment, the user interface 235 is configured to display the program, e.g., the missed call program.

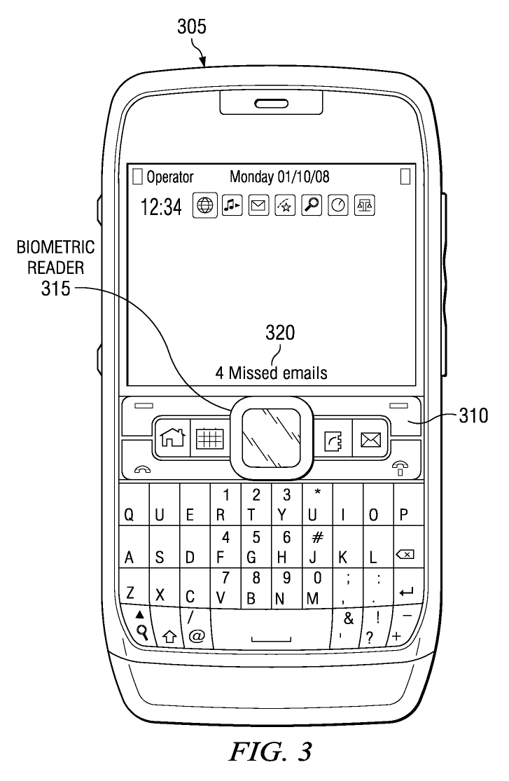

FIG. 3 is a block diagram depicting an electronic device 305 having a biometric reader 315 for authenticating a user in accordance with an example embodiment of the invention.

In an example embodiment, the electronic device 305 comprises a user interface 320, an interactive area 310, and/or the like. In an embodiment, the interactive area 310 comprises a biometric reader 315. In an example embodiment, electronic device 305 is similar to electronic device 205 of FIG. 2, the user interface 320 is similar to the user interface 245 of FIG. 2 and the interactive area 310 is similar to the interactive area 210 of FIG. 2. In an alternative embodiment, electronic device 305, the user interface 320, and the interactive area 310 may be different than electronic device 205, the user interface 245 and the interactive area 210 of FIG. 2.

In an example embodiment, the interactive area 310 is activated based at least in part on a communication, such as communication 225 of FIG. 2, not being accessed. For example, the interactive area 310 is illuminated based at least in part on a missed call. In an alternative embodiment, an indicator, such as indicators 215a-d of FIGURE, may be activated based at least in part on the communication.

In an embodiment, the electronic device 305 is locked. The user interface 320 is configured to receive authentication information to be accessed. In an example embodiment, the biometric reader 315 is configured to send authentication information to the user interface 320 based at least in part on a finger print authentication. For example, the biometric reader 315 reads a user's fingerprint to authenticate the user. In an embodiment, a biometric template from the user is compared to records within a database and a closest match score is returned. The closest match score within an allowed threshold as known in the art allows the user to be authenticated.

In an embodiment, the biometric reader 315 is configured to send a signal to a processor, such as processor 255 of the electronic device 305. In an embodiment, the signal comprises an authentication message and/or a command associated with the received communication. For example, the signal comprises a message that the user is authenticated and/or a command to open a missed call program. In an example embodiment, the electronic device 305 is configured to unlock the electronic device 305 based at least in part on the authentication. Further, the user interface 320 of the electronic device 305 displays the program. It should be understood that the biometric reader 315 may be located on the user interface 310, one or more indicators, such as indicators 215a-d of FIGURE, a combination thereof, and/or the like.

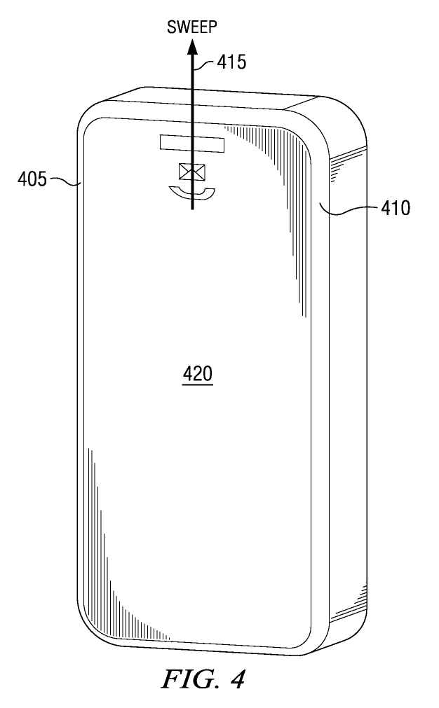

FIG. 4 is a block diagram depicting a selecting an indicator 410 on an electronic device 405 in accordance with an example embodiment of the invention.

In an example embodiment, the electronic device 405 comprises an indicator 410, a user interface 420, and/or the like. In an example embodiment, electronic device 405 is similar to electronic device 205 of FIG. 2 and/or electronic device 305 of FIG. 3, the user interface 420 is similar to user interfaces 245, 320 of FIG. 2 and FIG. 3 respectively, and the indicator 410 is similar to indicators 215a-d of FIG. 2. In an alternative embodiment, electronic device 405, the user interface 420, and the indicator 410 may be different than electronic device 205, electronic device 305, user interfaces 245, 320, and indicators 215a-d of FIG. 2.

In an example embodiment, a user interface 420 of the electronic device 405 is configured to detect a selection of the indicator 415. In an embodiment, the selection of the indicator 415 and/or interactive area relates to at least one of the following: a press, a touch, or a sweep. In an embodiment, a press relates to pushing or otherwise selecting a button. In an embodiment, a touch relates to a physical selection of a screen area, such as a touchscreen.

In an embodiment, a sweep moves or carries a finger over the user interface 420. For example, user interface 420 detects the user action, such as a sweep, beginning at the indicator 415 moving in a downward manner towards the bottom of the electronic device 405. In such a case, the sweep activates the indicator 415 as described above. It should be understood that the above is merely an example of a sweep and other techniques, such as a press or a touch may be employed. Further, many different forms and variations of selection as known in the art may also be employed. In an embodiment, the indicators may be located on an interactive area, such as interactive area 210 of FIG. 2.

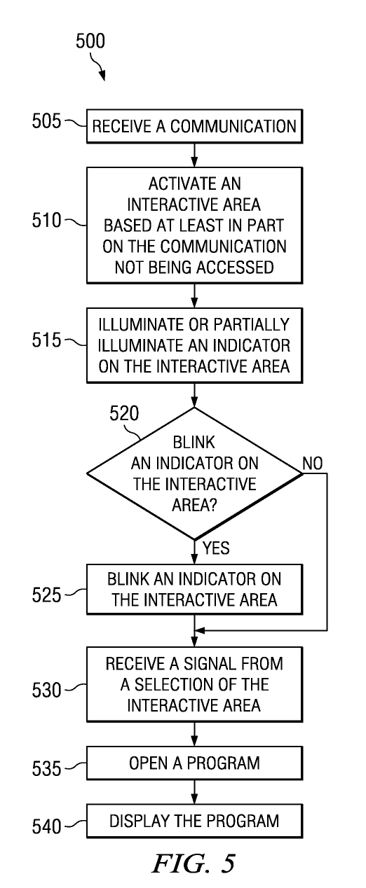

FIG. 5 is a flow diagram depicting an example method 500 for receiving a signal from a selection of an interactive area in accordance with an example embodiment of the invention. Example method 500 may be performed by an electronic device, such as electronic device 205 of FIG. 2.

At 505, a communication is received. In an example embodiment, a processor, such as processor 255 of FIG. 2, is configured to receive a communication. For example, the electronic device receives the communication, such as a mobile communication, via a basestation, such as basestation 230 of FIG. 2, from another electronic device, such as electronic device 220 of FIG. 2. In an example embodiment, the communication is at least one of the following: an email, a mobile communication, a calendar reminder, a calendar appointment, a message, and/or the like. In an example embodiment, the communication has not been accessed by a user of the electronic device. For example, the electronic device receives a phone call which is not answered resulting in a missed call.

At 510, an interactive area, such as interactive area 210 of FIG. 2, is activated based at least in part on the communication not being accessed. In an example embodiment, the processor of the electronic device is configured to activate the interactive area based at least in part on the communication not being accessed. For example, the interactive area is accessed based on a missed phone call, e.g., a mobile communication not accessed.

In an example embodiment, the interactive area comprises a plurality of indicators, such as indicators 215a-d of FIG. 2. In an embodiment, at least one of the plurality of indicators is at least one of the following: a hard key, a soft key, a touch screen, a biometric reader, and/or the like.

At 515, an indicator on the interactive area is illuminated or partially illuminated. In an example embodiment, the processor of the electronic device is configured to illuminate an indicator, such as indicator 215c of FIG. 2, on the interactive area to indicate a missed email. For example, the user interface of the electronic device illuminates the indicator. In an alternative embodiment, the processor of the electronic device may be configured to partially illuminate the indicator on the interactive area. For example, the processor illuminates a portion of the indicator. A possible technical effect of one or more of the example embodiments disclosed herein is to provide an illuminated indicator for a communication that has not been accessed.

At 520, it is determined whether the indicator on the interactive area is to blink. If at 520, it is determined that the indicator on the interactive area is to blink, then at 525, the indicator on the interactive area blinks. In an example embodiment, a user interface, such as user interface 245 of FIG. 2, is configured to blink the indicator. In an embodiment, the indicator blinks consistent with the number of communications not accessed. For example, indicator may blink two times to indicate two missed emails. In an embodiment, the indicator may repeat the blinking after stopping. The example method 500 continues at 530. If at 520, it is determined that the indicator on the interactive area is not to blink, then the example method 500 continues at 530.

At 530, a signal from a selection of the interactive area is received. In an example embodiment, the processor of the electronic device is configured to receive a signal from a selection of the interactive area. For example, the processor receives a signal based at least in part on a user selection, such as pressing the indicator. Further, the user interface 245 is configured to receive authentication information to be accessed. For example, the user interface is awaiting a user name and password to be unlocked.

At 535, a program is opened. In an example embodiment, the processor is configured to open a program associated with the communication. For example, the processor 255 opens the missed calls program based at least in part on the command in the signal, which is associated with the communication, e.g., a missed call. In an embodiment, the signal comprises authentication information and a command associated with the communication to open a program. In an example embodiment, the command is an open command for a program. For example, the signal comprises a user name and password and a command to open a missed call program resulting in opening of the program without entering authentication information. A possible technical effect of one or more of the example embodiments disclosed herein is to open access a program without entering authentication information.

At 540, the program is displayed. In an example embodiment, the user interface is configured to display the program, e.g., the missed call program. For example, the user interface displays a program indicating the missed emails. The example method 500 ends.

Without in any way limiting the scope, interpretation, or application of the claims appearing below, it is possible that a technical effect of one or more of the example embodiments disclosed herein is to open access a program without entering authentication information. Another possible technical effect of one or more of the example embodiments disclosed herein is to open access a program without entering authentication information.

Embodiments of the present invention may be implemented in software, hardware, application logic or a combination of software, hardware and application logic. The software, application logic and/or hardware may reside on an electronic device, a service, or a server. If desired, part of the software, application logic and/or hardware may reside on an electronic device, part of the software, application logic and/or hardware may reside on a service, and part of the software, application logic and/or hardware may reside on a server. The application logic, software or an instruction set is preferably maintained on any one of various conventional computer-readable media. In the context of this document, a “computer-readable medium” may be any media or means that can contain, store, communicate, propagate or transport the instructions for use by or in connection with an instruction execution system, apparatus, or device.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. An apparatus, comprising:
a processor configured to:
receive a communication, the communication having not been accessed;
activate an interactive area based at least in part on the communication not being accessed; and
receive a signal from a selection of the interactive area.

2. The apparatus of claim 1 wherein the communication is at least one of the following: an email, a mobile communication, a calendar reminder, a calendar appointment, or a message.

3. The apparatus of claim 1 wherein the processor is further configured to illuminate an indicator on the interactive area or partially illuminate the indicator on the interactive area.

4. The apparatus of claim 1 wherein the processor is further configured to open a program associated with the received communication.

5. The apparatus of claim 1 further comprising a biometric reader configured to use a finger print for authentication.

6. The apparatus of claim 1 wherein accessed relates to at least one of the following: answering a mobile communication, viewing a received email, viewing a calendar reminder, viewing a calendar appointment, or viewing a received message.

7. The apparatus of claim 1 wherein the interactive area further comprising a plurality of indicators.

8. The apparatus of claim 7 wherein at least one of the plurality of indicators is related to at least one of the following: answering a mobile communication, viewing a received email, viewing a calendar reminder, viewing a calendar appointment, or viewing a received message.

9. The apparatus of claim 1, wherein the processor comprises at least one memory that contains executable instructions that if executed by the processor cause the apparatus to receive a communication, activate an interactive area based at least in part on the received communication, and receive a signal from a selection of the interactive area.

10. A method, comprising:
receiving a communication, the communication having not been accessed;
activating an interactive area based at least in part on the communication not being accessed; and
receiving a signal from a selection of the interactive area.

11. The method of claim 10 wherein the communication is at least one of the following: an email, a mobile communication, a calendar reminder, a calendar appointment, or a message.

12. The method of claim 10 further comprising at least one of the following illuminating an indicator on the interactive area or partially illuminating the indicator on the interactive area.

13. The method of claim 10 wherein the signal comprises authentication information and a command associated with the received communication.

14. The method of claim 10 further comprising opening a program associated with the received communication.

15. The method of claim 10 using a finger print for authentication.

16. The method of claim 10 wherein accessed relates to at least one of the following: answering a mobile communication, viewing a received email, viewing a calendar reminder, viewing a calendar appointment, or viewing a received message.

17. The method of claim 10 wherein the interactive area further comprising a plurality of indicators.

18. The method of claim 17 wherein at least one of the plurality of indicators is related to at least one of the following: answering a mobile communication, viewing a received email, viewing a calendar reminder, viewing a calendar appointment, or viewing a received message.

19. The method of claim 17 wherein at least one of the plurality of indicators blinks consistent with the number of communications not accessed.

20. A computer-readable medium encoded with instructions that, when executed by a computer, perform:
receiving a communication, the communication having not been accessed;
activating an interactive area based at least in part on the communication not being accessed; and
receiving a signal from a selection of the interactive area.

21-35. (canceled)
